(19) United States
(12) Patent Application Publication
(10) Pub. No.: US 2025/0190502 A1
(43) Pub. Date: Jun. 12, 2025

(54) PROACTIVE FEATURE OUTAGE DETECTION

(71) Applicant: Google LLC, Mountain View, CA (US)

(72) Inventors: Jaya Singhvi, Campbell, CA (US); Mahesh Sunil Palekar, Cupertino, CA (US); Xianzhi Wang, Sunnyvale, CA (US); Eric Christopher Tassone, Charlottesville, VA (US); Mehdi Moradi, San Jose, CA (US); Xinrui He, Mountain View, CA (US); Farzan Rohani, Menlo Park, CA (US)

(21) Appl. No.: 18/535,407

(22) Filed: Dec. 11, 2023

(51) Int. Cl. G06F 16/9535; G06F 11/34

(52) U.S. Cl. CPC G06F 16/9535; G06F 11/3438

(57) ABSTRACT

A method is disclosed for detecting feature outages in a user interface by observing user behaviors in response to interactions with the user interface. The method involves calculating aggregated user behavior metrics for a most recent detection period and comparing them with aggregated user behavior metrics for a prior detection period to determine if they fall within an expected range. If the aggregated user behavior metrics for the most recent detection period are found to be outside the expected range, an action is initiated. This method enables the timely detection of feature outages in the user interface based on predictive user behaviors, allowing for prompt remedial actions to be taken.

### BACKGROUND

Systems that deliver Internet-based user interfaces can suffer from feature outages. A feature outage occurs when a feature offered in a user interface, such as a search result page, fails to operate as expected. For example, failure to display expected image thumbnails may be one type of feature outage; failure to display an expected onebox answer or knowledge panel may be a type of feature outage, displaying a garbled user interface (with overlapping text/images, margins that are too big, etc.), may be another type of feature outage, having duplicate search results in the search result page may be a type of feature outage, etc. Feature outages can be caused by software releases (updates) that include undetected bugs and/or by communication issues between services/systems.

### SUMMARY

Implementations relate to proactively detecting a feature outage based on observed user behavior metrics. In particular, an outage detection system may monitor counts of different types of user interactions with a user interface, each type of interaction representing a different type of user behavior, and aggregate those counts during detection periods. A detection period is a window during which monitored behavior occurs (e.g., 15 minutes, 30 minutes, 1 hour, etc.). The aggregation can be for different attributes, e.g., by vertical, by source, by user classification, etc. This aggregated data can be used to create time series data, which can be used to determine expected behavior metrics. Implementations may use the time series data to determine if the aggregated counts in a most recent detection period are within an expected range (e.g., within a confidence interval). In some implementations, when a majority of the monitored behaviors fall outside the expected range the system may determine a feature outage exists; this determination can be made without knowing what the feature is. In some implementations, a machine-learned model may be used to determine whether the aggregated counts in the most recent detection period are within the expected range. If the system determines the user behavior metrics for the most recent detection period fall outside the expected metrics, the system can initiate an alert action. An alert action can include a notification. An alert action can include an update rollback. An alert action can include taking a particular server or source offline. An alert action can include a notification to an account associated with a source. Disclosed implementations enable a system to proactively identify feature outages, without testing for any specific outage, which reduces the exposure of the outage to users and minimizes negative attention drawn to the feature provider.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram that illustrates an example environment in which improved techniques described herein may be implemented.

FIG. 2 is a diagram that illustrates an example outage detection system, according to disclosed implementations.

FIG. 3 is a diagram that illustrates an example method for proactively detecting feature outages, according to disclosed implementations.

FIG. 4 is a diagram that illustrates an example of a distributed computer device that can be used to implement the described techniques.

### DETAILED DESCRIPTION

This disclosure relates to methods for detecting a feature outage. A feature outage occurs when a feature offered in an online service, such as a search engine or other Internet-based user interface, fails to operate as expected. For example, a feature outage may be failure to display expected image thumbnails, failure to display an expected answer box or an entity panel, displaying a garbled user interface (overlapping text/images, etc.), having duplicate search results in a search result page, etc. Feature outages are often caused by software releases (including releases used in A/B testing) that include undetected bugs and/or that cause communication problems with services/systems. Feature outages can be difficult to detect proactively in a timely manner but can result in poor user experiences and unwelcome media coverage, both of which may negatively affect usage of the service.

Proactively and timely identifying a feature outage is difficult but has been a long desired capability for software service providers, including search engines. Rules-based outage detection systems are brittle, slow, and mostly backward looking because it is impossible to anticipate every point of failure ahead of time. Thus, there has been a longstanding technical problem of how to identify feature outages proactively and quickly (e.g., minimizing the number of affected users).

To address the issue of proactively identifying feature outages to minimize the number of affected users, implementations use analysis of user behavior metrics to identify feature outages. In particular, implementations do not look for a particular problem (a particular feature outage), but instead use the reactions of users to the interface to identify that a problem exists (feature outage, feature failure) with the interface. In other words, disclosed implementations use information about users changing their reactions to search results (or a user interface associated with another type of service) to predict the existence of a feature failure, even if the affected feature remains unknown. Once the existence of a feature failure is identified, an action can be initiated to address the outage. For example, human operators can be timely notified, which enables them to analyze and remedy the feature outage before it affects too many users. The alert may save hours or even days between the beginning of the outage and its remedy. As another example, an auto-rollback of a software code change can be triggered. The action can include taking a source (server) on which the code change was installed out of service (e.g., so that it no longer responds to requests), which addresses A/B testing involving a limited rollout that introduces a feature outage.

More specifically, implementations identify user behaviors (types of user interactions with a user interface) that change (increase or decrease) from expected levels during feature outages. A behavior metric for a user behavior can be a count of the instances of the user behavior observed. A behavior metric for a user behavior can be a percentage of the instances of the user behavior observed over a total population, e.g., over a population of queries. Each instance can be considered a behavior event for the user behavior. In other words, the behavior metrics can be counts or can be ratios representing how common the behavior occurs within a defined population (e.g., a query vertical, a device type, etc.). While one or two of the user behavior metrics may change from expected levels during non-outage events, a change in a majority of the monitored behaviors highly correlates with feature outages (as opposed to other events). The type of behaviors used to determine behavior metrics (the monitored behaviors) can be dependent on the type of user interface. For a search engine, the user behaviors include organic clicks, duplicate queries within a minute, and manual query refinement within one minute. Organic clicks represent queries with a selection of a search result (not an advertisement) that sends a user to a host site from the search result page for the query. Duplicate queries within a minute represent submission of queries that functionally duplicate an earlier query submitted within the prior minute. Functionally duplicate queries can be queries that result in a search result page with the same top (top one, two, three, etc.) ranked resource/resources. Functionally duplicate queries can be explicitly duplicate queries, e.g., where the query string is exactly the same. Manual query refinement represents queries that are followed within a short behavior window (e.g., one minute) by a manual refinement (rather than a query refinement suggested by the search engine/on the search result page). In other words, a manual refinement occurs when the user adds one or more terms to or deletes one or more terms from the query within a behavior window. Another user behavior that can be used is a page refresh that occurs before an organic click and within one minute of display of the search result page. Although one minute is used as an example behavior window above, a behavior window can be any predetermined length of time and implementations can use other behavior windows, such as 30 seconds, two minutes, etc.

Because different user interfaces can be presented in response to different queries, implementations may track these behavior metrics within different verticals. A vertical is a class of user interfaces that can be presented in response to user input, thus different user interfaces represent different verticals. In a search engine example, different user interfaces may be used to respond to different types of queries, so a query may belong to a vertical (e.g., sports queries, weather queries, travel queries, map queries, shopping queries, etc.) Typically, each vertical provides a specific type of search result page element (e.g., a query of football or hockey may include an interactive panel of the upcoming matchups between professional sports teams or a query that corresponds to the name of a sports team may bring up a similar element showing the past and future matchups for that team), and the feature outage can be related to that element. Implementations monitor behaviors within verticals so that changes in the user behaviors due to a feature outage specific to the vertical do not get lost, e.g., as noise across verticals. Put another way, a feature failure may only occur for certain queries (certain verticals), which may be a small fraction of all queries. Thus, unless behaviors are measured within the vertical, the changes in behavior will be statistically too small to be noticed. Monitoring user behavior within vertical also has the benefit of narrowing what feature (or set of features), or subsystem, may be experiencing an outage. Monitoring user behavior within vertical may be considered monitoring user behavior by (within) a particular user interface.

In some implementations, the user behavior metrics can also be measured by source. A source may represent a device type (e.g., a mobile device, a wearable device, a laptop/desktop device, etc.) because different user interfaces may be generated for different device types. A source may represent a source server, e.g., a server that handles the query and generates the search result page. In a distributed computing environment, several different servers may be used to respond to user requests (such as queries) and developers may update a single server with new software, e.g., to conduct A/B testing. Thus, user interfaces generated by the updated server may differ from user interfaces generated by the other servers in the distributed environment and the feature outage may only occur on the updated server. Calculating behavior metrics by source (by server and/or by device type) may enable the system to pinpoint the changes in behavior on the updated server. This helps the system identify a particular source as the issue and an address associated with the source can be notified of the probable existence of the feature outage. In some implementations, the system may calculate (aggregate) behavior metrics by user type, as described herein.

Implementations can use time series data to determine whether there is an anomaly in the metrics for the user behaviors. In some implementations, metrics from the previous day may be used to determine what is expected from the most recent detection period. In some implementations, metrics from a prior detection period/periods having the same attributes as the most recent detection period (e.g., same day of week, same time of day, same geographic location, etc.) may be used to determine the expected range. In some implementations, a majority of the monitored user behavior metrics being outside the expected range may be interpreted as the existence of a feature outage. In some implementations, a machine-learned model may use time series clustering to predict a confidence interval and/or predict whether user behavior metrics for a current detection period fall within a predicted confidence interval. In particular, for queries within a vertical (and potentially within a source and/or user category), the number of queries with organic clicks, duplicate queries within a behavior window (e.g., one minute), and manual query refinement within one minute during a detection period (e.g., 15 minutes, one hour) are recorded. This aggregate number may be compared against a confidence interval prediction for the model. In other words, the model may provide a confidence interval prediction of what is expected, and if a majority of the metrics from the most recent period are outside the confidence intervals a feature outage has been detected. In some implementations, the model may provide a prediction of whether the metrics for the most recent detection period represent a feature outage. In other words, given the metrics for the most recent detection period, the model may provide an indication of whether or not the metrics for the most recent detection period represent a feature outage.

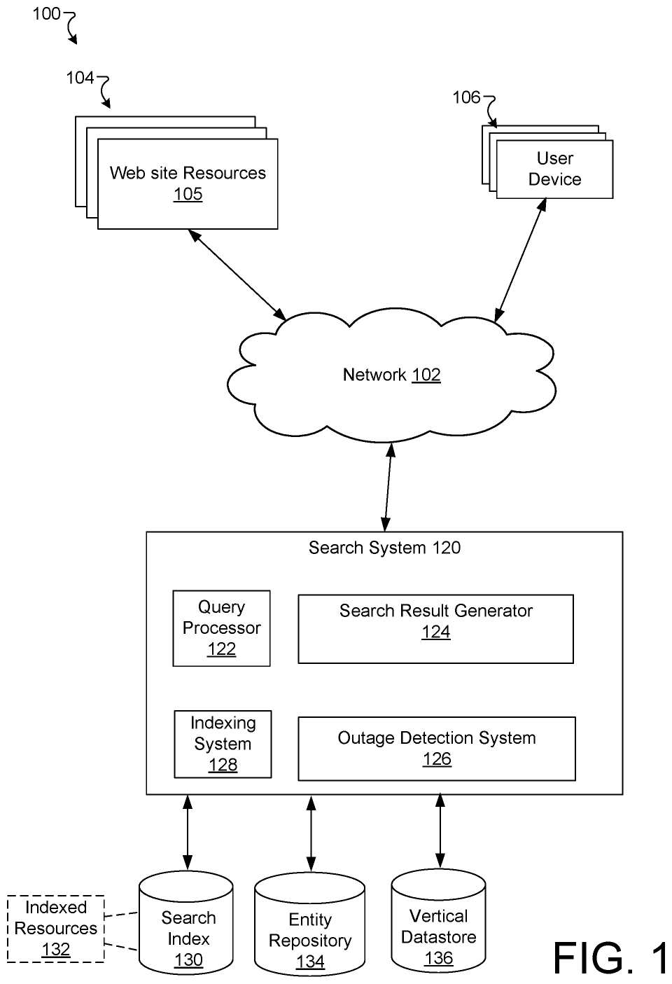

FIG. 1 is a diagram that illustrates an example environment 100 in which improved techniques described herein may be implemented. In the example of FIG. 1, a search system 120 is discussed as the online service. However, this is an example service and implementations can be adapted to other online services based on the example of search system 120. Moreover, while the search system 120 of FIG. 1 is described as an Internet search engine, the techniques here can be adapted to more specific search engines. For example, a shopping search engine, or a video search engine may not need to calculate metrics by vertical, or may have different verticals, or may use different/additional user behavior metrics. As used herein, resources can refer to any content accessible to a search engine. Thus, resources include web pages, images, documents, media, etc.

In the example of FIG. 1, the environment 100 includes a network 102, e.g., a local area network (LAN), wide area network (WAN), the Internet, or a combination thereof, connects web sites 104, user devices 106, and the search system 120. In some examples, the network 102 can be accessed over a wired and/or a wireless communications link. For example, mobile computing devices, such as smartphones can utilize a cellular network to access the web sites 104 and/or the search system 120. In some examples, the search system 120 can access the web site 104 via the Internet. The environment 100 may include millions of web sites 104 and user devices 106.

The search system 120 can include, among other things, an indexing system 128, a query processor 122, a search result generator 124, and an outage detection system 126. In some implementations, the indexing system 128, query processor 122, and search result generator 124 may be co-located, e.g., at a server. In some implementations, one or more of the indexing system 128, the query processor 122, and/or the search result generator 124 may be remote from but communicatively coupled with each other, e.g., at different servers that communicate with each other. Any one of the query processor 122, search result generator 124, outage detection system 126, and indexing system 128 can be implemented in a set of distributed servers.

In some examples, a web site 104 is provided as one or more resources 105 associated with an identifier, such as domain name, and hosted by one or more servers. An example web site is a collection of web pages formatted in an appropriate machine-readable language, e.g., hypertext markup language (HTML), that can contain text, images, multimedia content, and programming elements, e.g., scripts. An example web site can also be resources that support an application, such as a native application, a web application, a progressive web application, an installable web application, etc. Thus, a web site 104 can include user interfaces and/or application program interfaces that support an application. Each web site 104 is maintained by a publisher, e.g., an entity that manages and/or owns the web site. Web site resources 105 can be static or dynamic (generated based on data provided in a request). In some examples, a resource 105 is data provided over the network 102 and that is associated with a resource address, e.g., a uniform resource locator (URL). In some examples, resources 105 that can be provided by a web site 104 include web pages, word processing documents, and portable document format (PDF) documents, images, video, and feed sources, among other appropriate digital content. The resources 105 can include content, e.g., words, phrases, images and sounds and may include embedded information, e.g., meta information and hyperlinks, and/or embedded instructions, e.g., scripts.

In some examples, a user device 106 is an electronic device that is under control of a user and is capable of requesting and receiving resources 105 over the network 102. Example user devices 106 include personal computers, mobile computing devices, e.g., smartphones, wearable devices, and/or tablet computing devices, etc., that can send and receive data over the network 102. As used throughout this document, the term mobile computing device (“mobile device”) refers to a user device with a limited display area that is configured to communicate over a mobile communications network. A smartphone, e.g., a phone that is enabled to communicate over the Internet, is an example of a mobile device, as are wearables and other smart devices such as smart speakers, although these may be considered as a different device type (e.g., a wearable type or a speaker type) than a smartphone. A desktop device can refer to a computing device conventionally used at a desk (e.g., a laptop, netbook, desktop, etc.). A user device 106 typically includes a user application, e.g., a web browser, to facilitate the sending and receiving of data over the network 102.

The user device 106 may include, among other things, a network interface, one or more processing units, memory, and a display interface. The network interface can include, for example, Ethernet adaptors, Token Ring adaptors, and the like, for converting electronic and/or optical signals received from the network to electronic form for use by the user device 106. The set of processing units include one or more processing chips and/or assemblies. The memory includes both volatile memory (e.g., RAM) and non-volatile memory, such as one or more ROMs, disk drives, solid state drives, and the like. The set of processing units and the memory together form controlling circuitry, which is configured and arranged to carry out various methods and functions as described herein. The display interface is configured to provide data to a display device for rendering and display to a user.

In some examples, to facilitate searching of resources 105, the search system 120 includes an indexing system 128 identifies the resources 105 by crawling and indexing the resources 105 provided on web sites 104. The indexing system 128 may index data about and content of the resources 105, generating search index 130. In some implementations, the fetched and indexed resources 105 may be stored as indexed resources 132. In some implementations, the search index 130 and/or the indexed resources 132 may be stored at the search system 120. In some implementations, the search index 130 and/or the indexed resources 132 may be accessible by the search system 120. In some implementations, the search system 120 may have access to an entity repository 134. The entity repository 134 can be accessed to provide factual responses to a factual query and/or to help with ranking resources responsive to a query. The entity repository 134 can be referred to as a knowledge base, a knowledge graph, or a fact repository. In some implementations, the search system 120 may use the entity repository 134 to generate a box answer or a factual panel (knowledge panel) in response to a query that corresponds to an entity. In some implementations, the format of the knowledge panel may be based on the vertical of the query (e.g., a sports entity, a shopping entity, a person entity, a movie entity, etc.). In some implementations, the search system 120 may have access to vertical datastore 136. Vertical datastore 136 can represent any datastore/database that provides additional information for queries in a specific vertical. Thus, for example, a weather query may have access to a datastore that provides weather information, or a sports query may have access to a datastore that provides specific sports information. One or more vertical datastore 136 can be accessed via an application program interface (API) call.

The user devices 106 submit search queries to the search system 120. In some examples, a user device 106 can include one or more input modalities. Example input modalities can include a keyboard, a touchscreen, a camera, a mouse, a stylus, and/or a microphone. For example, a user can use a keyboard and/or touchscreen to type in a search query. As another example, a user can speak a search query, the user speech being captured through the microphone, and processed through speech recognition to provide the search query. As another example, a user can submit an image or an area of an image as a query (e.g., from a camera, a screenshot, a portion of a display, an image on a web page, etc.).

The search system 120 may include query processor 122 and/or search result generator 124 for responding to queries issued to the search system 120. In response to receiving a search query, the query processor 122 may process (parse) the query and access the search index 130 to identify resources 105 that are relevant to the search query, e.g., have at least a minimum specified relevance score for the search query. Processing the query can include applying natural language processing techniques and/or template comparison to determine a type of the query. The query processor 122 can determine a vertical of the query. The resources searched, the ranking applied, the search result elements, and/or user interface elements included in a search result page may be dependent on the vertical of the query, the type of the query (e.g., a factual query (e.g., expecting a factual answer), a complex query (e.g., expecting a multi-faceted answer), a navigational query (e.g., expecting a resource), etc.) and/or the type of the user device 106 that issued the query. Thus, a query can be a factual query in the sports vertical or can be a navigational query in the sports vertical. The query processor 122 may perform disambiguation if an entity in a query or a type of the query is ambiguous. In some implementations, ambiguous queries may be treated as their own vertical (e.g., with a user interface that addresses the ambiguities).

The search system 120 may identify the resources 132 that are responsive to the query and generate a search result page. The search result page includes search results and can include other content, such as ads, entity (knowledge) panels, box answers, entity attribute lists (e.g., songs, movie titles, etc.), short answers, generated responses (e.g., from a large language model), other types of rich results, links to limit the search to a particular resource type (e.g., images, travel, shopping, news, videos, etc.), other suggested searches, etc. Each search result corresponds to a resource available via a network, e.g., via a URL/URI/etc. The resources represented by search results are determined by the search result generator 124 to be top ranked resources that are responsive to the query. In other words, the search result generator 124 applies a ranking algorithm to the resources to determine and order in which to provide search results in the search result page. A search result page may include a subset of search results initially, with additional search results (e.g., for lower-ranked resources) being shown in response to a user selecting a next page of results (e.g., either by selecting a ‘next page’ control or by continuous scrolling, where new search results are generated after a user reaches and end of a currently displayed list but continues to scroll).

Each search result includes a link to a corresponding resource. Put another way, each search result includes a link to a host site (a web site 104) from the search result page. Each search result may be considered to represent/be associated with a resource. Clicking on (selecting) a search result is an organic click. The search result can include additional information, such as a title from the resource, a portion of text obtained from the content of the resource (e.g., a snippet), an image (thumbnail) associated with the resource, etc., and/or other information relevant to the resource and/or the query, as determined by the search result generator 124 of the search system 120. In some implementations, the search result may include a snippet from the resource and an identifier for the resource. For example, where the query was issued from a device or application that received the user query via voice, the search result may be a snippet that can be presented via a speaker of the user device 106. The search result generator 124 may include a component configured to format the search result page for display or output on a user device 106. The search system 120 returns the search result page to the query requestor. For a query submitted by a user device 106, the search result page is returned to the user device 106 for display, e.g., within a browser, on the user device 106.

The search result page can include other user interface elements, such as a short answer, a box answer (e.g., an interactive box), entity facts, e.g., in a knowledge panel, a carousel of related entities, etc. In some implementations, the format of the search result page may be determined by query vertical and/or query type. Thus, for example, queries that reference sport teams may include user interface elements on the search result page that are specific to sport teams (team rosters, team schedules, etc.). In some implementations, the user interface elements can be driven by a location associated with the query and/or date query was issued. Each query vertical and/or query type may include different user interface elements representing different features.

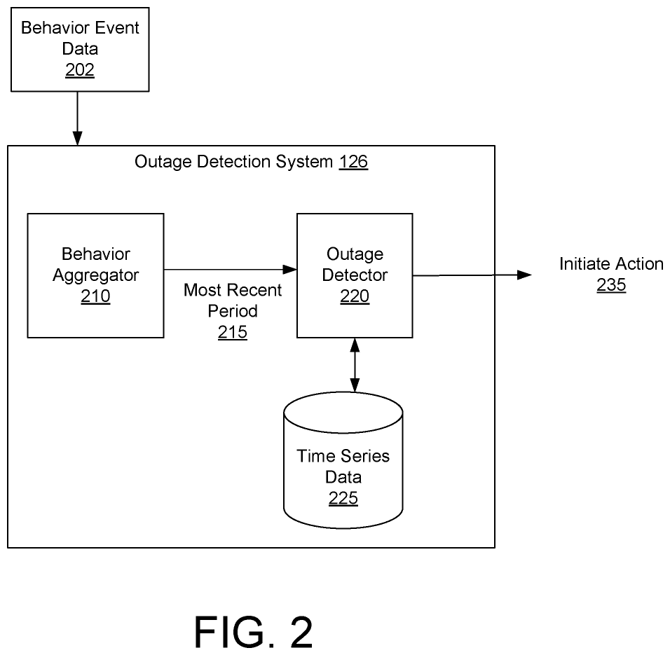

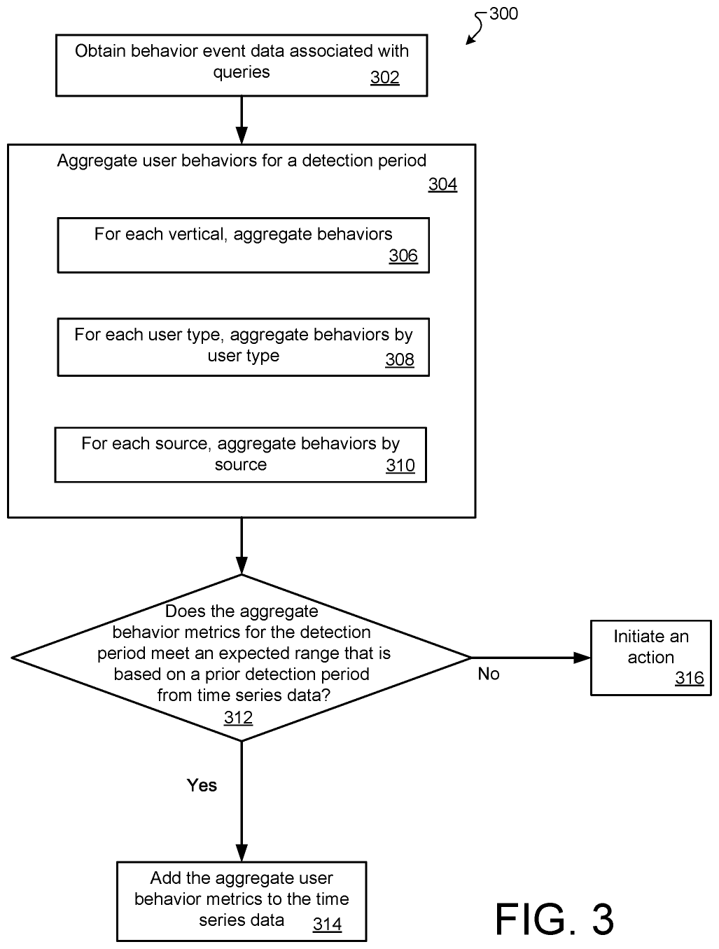

In disclosed implementations, the search system 120 includes an outage detection system 126. The outage detection system 126 may be used by the search system 120 to monitor user behavior in response to queries in specific verticals. The user behavior occurrences can be reported as behavior event data from the user device 106. In other words, the outage detection system 126 may receive a numeric indication of a particular user behavior, e.g., an indication that the behavior occurred, what it's associated timestamp is, the query or query vertical it applies to, a classification of the user, a sub-vertical within the vertical (e.g., a particular sport like soccer, cricket, basketball, hockey, with a Sports vertical), a language used by the user, a generalized location (e.g., city, state, country, time zone, etc.) of the user, and/or a device type, but no user information. In other words, the behavior event data cannot be used to tie the behavior events back to any particular user. Each indication of a behavior is a behavior event. Thus, a behavior event includes data that identifies the type of user behavior and a timestamp. The behavior event may include the query or query vertical the behavior event applies to. The outage detection system 126 can use the collected metrics to determine the user behavior metrics during a detection period. For example, the outage detection system 126 may know the number of queries in a particular vertical that were received during the detection period and may aggregate the collected metrics to calculate (determine) aggregated user behavior metrics for the detection period. The aggregation is described in more detail with respect to FIGS. 2 and 3. The outage detection system 126 stores the aggregated user behavior metrics as time series data, which can be used to determine expected behavior. When the metrics for a particular detection period fall outside of what is expected the outage detection system 126 may determine the existence of a feature outage is likely and initiate an action. In some implementations, a majority of the user behavior metrics falling outside what is expected based on the historical data may be considered a likely feature outage. In some implementations, an outlier detection model may be used to determine the existence of a feature outage. The action may include sending a notification to an address associated with the vertical and/or the source associated with the metrics. The action may include rolling back a software update to the source. The action may include taking the source offline or otherwise preventing the source from responding to queries.

FIG. 2 is a diagram that illustrates an example outage detection system 126, according to disclosed implementations. In some implementations, the outage detection system 126 is configured to generate time series data 225. In some implementations, the outage detection system 126 is configured to initiate an action 235 in response to determining that behavior metrics for a most recent detection period are outside of the expected metrics, e.g., based on the time series data 225. In some implementations, the action may be a notification action. In some implementations, the action may be a rollback. In some implementations, the action may be decommissioning a source (e.g., a particular server, a particular service at the server, such as a service for responding to requests form mobile devices and another service for responding to requests from desktop devices). In some implementations, the outage detection system 126 represents a system configured for a particular vertical. Thus, for example, a search system 120 can include a first outage detection system 126 for a first vertical and a second outage detection system 126 for a second vertical. The user behaviors and/or the data included in the time series data 225 may be different in the first outage detection system 126 and the second outage detection system 126 because of the different verticals.

The outage detection system 126 receives behavior event data 202. The behavior event data 202 can be generated by the search system 120. For example, the search system 120 can determine whether or not a query from the same user is a duplicate query or a manual refinement that occurs within a behavior window (e.g., one minute). In such an implementation, the search system 120 may generate behavior event data 202 for that behavior event. In some implementations, the behavior aggregator 210 may obtain the total number of queries received during a detection period for the query vertical. This may be used in calculating percentages of queries for which a certain behavior occurs. In some implementations, the behavior event data 202 can be generated by a user device, such as user device 106. For example, a user device may provide an indication of the type of user behavior (organic click, query refinement, query duplicate, etc.) and a timestamp for the behavior event. In some implementations, the user device may provide an associated query vertical for the behavior event in the event data. In some implementations, with user permission, the user device may provide a user category for the behavior event in the event data. The user category may represent a classification of the user based on how often the user performs the behavior, or in other words, the frequency of the user behavior over an assignment period. For example, users could be classified into low, medium, and high classes, where users who perform the behavior the least often are classified into the low class, users who perform the behavior most frequently are classified into the high class and remaining users are classified into the medium class. In some implementations, the low class may represent a bottom quartile of users, the high class a top quartile of users. In some implementations, users who have a statistical rate of zero for the behavior may be classified in a zero class. In other words, some implementations may include zero, low, medium, and high classes. The classification may be based on observations over a period of time, e.g., two weeks, three weeks, four weeks, two months, etc. This period of time may be referred to as an assignment period. Thus, for example no classification may be included in the behavior event data 202 for a behavior type until after the assignment period. The classification can be reported as a flag in the behavior event data 202, so the classifications are not tied back to/attributable to the user. The metadata provided in the behavior event data 202 for a behavior event may be used for aggregating the metrics during a detection period, as explained herein.

The outage detection system 126 may include behavior aggregator 210. The behavior aggregator 210 is configured to aggregate the behavior event data 202 for a detection period. The behavior aggregator 210 may determine counts and/or percentages by aggregating behavior events based on attributes of the behavior events. The attributes can include behavior type, vertical, source, user classification, etc. The aggregation occurs for events that fall within the same detection period. In some implementations, the behavior aggregator 210 may calculate the number of behavior events of a certain behavior type during a detection period. The behavior types included in the detection event data 202 can be dependent on the implementation. In a search system, the behavior types can include organic clicks, manual query refinement within a behavior window (e.g., 1 minute), and functionally duplicate queries submitted with the behavior window (e.g., 1 minute). In some implementations, the behavior aggregator 210 may calculate the percentage of queries for which the behavior was observed (e.g., the count of behavior events of the behavior type divided by the total number of queries the search system 120 responded to during the detection period). A user behavior metric can include the count and/or the percentage of each behavior type.

In some implementations, the behavior aggregator 210 may calculate the number of each type of behavior by query vertical that occurred during the detection period. In some implementations, the behavior aggregator 210 may calculate the number of each type of behavior by query vertical and source. In some implementations, the behavior aggregator 210 may calculate the number of each type of behavior by query vertical and user category. In some implementations, the behavior aggregator 210 may calculate the number of each type of query behavior by query vertical, user category, and source. In some implementations, the behavior aggregator 210 may calculate the number of each type of query behavior by query vertical and device type. In some implementations, the behavior aggregator 210 may calculate the number of each type of query behavior by query vertical, generalized location, and device type. Put another way, the behavior aggregator 210 can calculate counts from the behavior event data 202 based on any combination of behavior type, query vertical, user classification, device type, generalized location, and/or source. In some implementations, the behavior aggregator 210 may calculate percentages for the aggregated counts, e.g., for each count, what percent that count represents for the same attributes (of query vertical, behavior type, device type, source). In some implementations, user classification may be used to reduce the aggregated metrics. For example, behavior event data 202 for users in a high classification may be excluded from the aggregated counts. In some implementations, user classification may be used to weigh the behavior event data 202. For example, behavior event data 202 for users in a low or medium classification may be weighted higher than behavior event data 202 for users in a high classification. As another example, behavior event data 202 for users in a low classification may be weighted more than behavior event data 202 for users in a medium classification, and behavior event data 202 for users in a high classification may have no weight applied or may have a lowest weight applied. In some implementations, behavior data 202 for different user classifications may have different baselines for user metrics.

The behavior aggregator 210 may output the aggregated behavior metrics for a most recent detection period 215. In some implementations, e.g., where the system is building the time series data 225, these metrics may be stored in the time series data 225. In some implementations, the metrics for the most recent detection period 215 may be provided to an outage detector 220. The outage detector 220 is configured to determine whether the metrics for the most recent detection period 215 are within an expected range (a confidence interval) based on a comparison with at least one prior detection period. In some implementations, the expected range may be based on a plurality of prior detection periods, e.g., detection periods from the prior 24 hours, detection periods from the same day of the week for the last n weeks, detection periods for the same day last year, etc. If the metrics for the most recent detection period 215 are not within the expected range based on the time series data 225, the outage detector 220 may initiate an action 235. In some implementations, if the metrics for the most recent detection period 215 is within the expected range the outage detector 220 may add the metrics for the most recent detection period 215 to the time series data 225. In some implementations, if the metrics for the most recent detection period 215 is outside the expected range the outage detector 220 may use the metrics for the most recent detection period 215 as a training example.

In some implementations, the outage detector 220 may include or use a machine-learned model, e.g., a feature outage detection model. The feature outage detection model may be a time series classification model trained to provide an indication of whether or not user behavior metrics for a most recent detection period 215 fall within a confidence interval (i.e., within expected range). The feature outage detection model may be a time series model trained to provide an expected range/expected ranges for user behavior metrics (i.e., the aggregated user behavior metrics), based on the time of day, day of the week, query vertical, and/or some other attribute and the time series data 225. In such implementations the outage detector 220 may compare the aggregated user behavior metrics for most recent detection period 215 with the expected range(s).

Although illustrated as part of the outage detection system 126 in FIG. 2, one or more components may be separate from the outage detection system 126 but accessible to the outage detection system 126, e.g., via an API call. For example, the outage detection system 126 may use a behavior aggregator 210 or an outage detector 220 that is a service provided by the search system 120 or another system. Put another way, the outage detection system 126 may use existing processes for certain functions.

FIG. 3 is a diagram that illustrates an example method 300 for proactively detecting feature outages, according to disclosed implementations. Method 300 may be executed in an environment, such as environment 100. In some implementations, one or more of the method steps may be executed by a system, such as outage detection system 126 of FIG. 2. In some implementations, one or more of the method steps may be executed by a model, such as a feature outage detection model. Not all steps need to be performed in some implementations. Additionally, the method steps can be performed in an order other than that depicted in FIG. 3.

At step 302, the system obtains behavior event data. The behavior event data represents counts of user behaviors in interactions with a user interface. For example, the behavior event data may represent instances of particular user behaviors observed during interactions with search result pages provided in response to queries. The queries may be queries in a particular vertical. The behavior event data may include a timestamp so the event instance can be assigned to a detection period. The detection period represents a tradeoff between proactivity and recall. A short detection period enables faster detection of a feature outage but risks not having sufficient data for which to make a determination. Generally, a detection period should be long enough that, on average, a minimum number of (e.g., 1000) queries can be observed during that time. In some implementations, the detection period may be 15 minutes. A longer detection period means a longer time to detection, but the longer time may be needed to reach the minimum number queries in the vertical. In some implementations the detection period may be an hour. In some implementations the length of the detection period can be based on the vertical, the device type, or another attribute used to calculate the aggregated metrics for a particular user behavior. In other words, if 15 minutes is long enough to receive, on average, 1000 queries for a first vertical or the first vertical and device type (source), the detection period may be 15 minutes for the first vertical, where a second vertical may need 30 minutes or an hour to average observation of the minimum number of queries needed to accurately reflect the expected behaviors.

At step 304, the system may calculate aggregated user behavior metrics for a detection period. In some implementations, the aggregated user behavior metrics include counts of behavior events, e.g., counting the observations of instances of each type of user behavior. Put another way, because the behavior event data represents instances of types of user behaviors, one metric may be a count of the occurrences, with each type of user behavior having a respective count calculated. The behavior metrics may be percentages of queries associated with the user behavior. For example, in some implementations, the system may have access to/may track the number of queries received during the detection period (by vertical, device type, source, etc.) and may calculate a ratio (percentage) of the number of (count of) instances of the behavior during the time period vs the total number of queries.

In some implementations, at step 306, the system may calculate the aggregated behavior metrics by query vertical. In such implementations, behavior events associated with the vertical are used in the number of event instances. If the behavior event data includes events for multiple verticals, a count may be calculated for each vertical. If the aggregated behavior metrics include a percentage, the total queries for that vertical may be used to calculate the percentage. In some implementations, at step 308, the system may calculate the aggregated behavior metrics by user type. User type may be the classification of the user based on the frequency with which the user performs the monitored behavior. In some implementations, the user types can be low, medium, or high. In some implementations, the user types can be zero, low, medium, or high. In such implementations, behavior events are aggregated within user type. In some implementations, users in a high frequency classification may be excluded from aggregation. Thus, aggregation by type may include excluding a user type from the aggregating. In some implementations, at step 310, the system may calculate the aggregated behavior metrics by source. Source can refer to a device type (e.g., desktop, mobile, wearable). Source can refer to a server identifier that generates the user interface (e.g., the search result page) in response to a query. The servers may be part of a distributed system. In A/B testing one server in the distributed system may be updated but the remaining servers are not. Aggregating by source can single out a server that is exhibiting a feature outage when the others are not. The aggregation by source can be done for comparison of metrics for a current detection period with expected metrics. The time series data may not include aggregation by source. In such an implementation, the metrics for all sources may be combined before being added to the time series data.

In some implementations, aggregation can be done on multiple attributes, e.g., by source within vertical, by user class within vertical, by user class and device type within vertical, etc. Moreover, the detection period can be dependent on an attribute, such as vertical or device type.

At step 312, the system compares the aggregate behavior metrics for the most recent detection period with an expected range/ranges. The expected range/ranges are determined from time series data that represents one or more prior detection periods. The prior detection periods may be selected based on common attributes with the most recent detection period, e.g., same time of day, same day of the week, etc. The prior detection period can be the detection periods representing a number of hours (e.g., 12, 24) preceding the most recent detection period. The prior detection period can be an average obtained for days of the week matching the current day of the week, days of prior months matching the current day of the month, same day of prior years, etc. In some implementations, step 312 may be performed by a machine-learned model that is trained on the time series data. In such implementations, the model may determine whether the aggregate behavior metrics fall within the expected range.

If the aggregated behavior metrics are within the expected range, at step 314, the system may add the aggregated behavior metrics to the time series data. If the aggregated behavior metrics for the most recent detection period fall outside the expected range, at step 316, the system may initiate an action to remedy the feature outage. The action could be sending an alert to an address (e.g., an email address, a phone number) associated with the query vertical or the source. The action could be sending an alert to a designated operator. The alert can include any information useful to pinpoint the feature outage (e.g., the source on which the behavior metrics fell outside the expected range, the query vertical for which the behavior metrics fell outside the expected range, etc.). The action may be an automatic rollback of an update. To automatically rollback an update, the system may have been notified of an update, so that any changes in the user behaviors can be attributed to that update. In some implementations, an automatic rollback may occur if the aggregated behavior metrics fall a threshold distance outside the expected range. Put another way, if the aggregated behavior metrics are close to but still outside of the expected range, a rollback may not be initiated, but if the aggregated behavior metrics are not close to the expected range, a rollback may be automatically initiated. The action can be storing the aggregated metrics for training a feature outage detection model. The action can be taking a source out of service, e.g., if an A/B test is being conducted the system may take action to prevent the updated source (server) from responding to queries. Any of these actions may be done in conjunction with any other action.

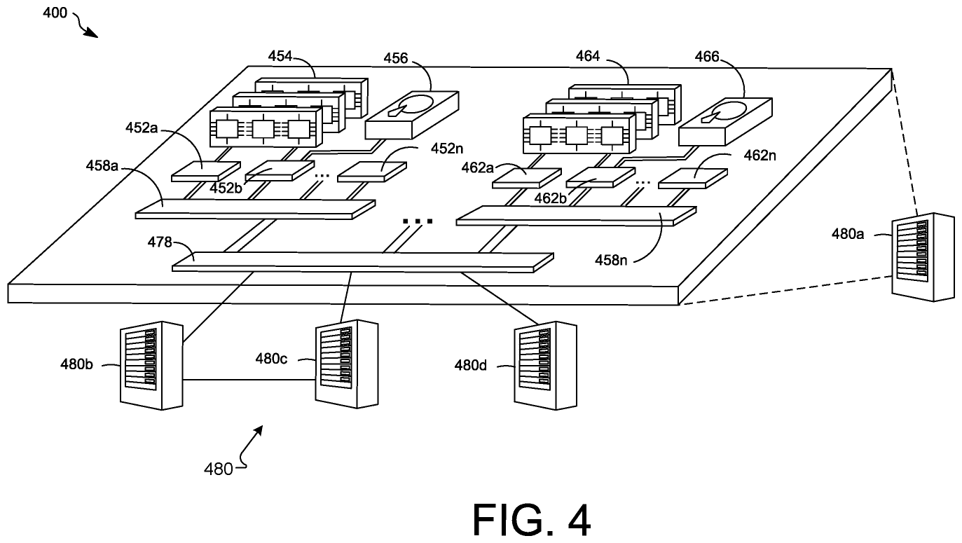

FIG. 4 shows an example of a computing device 400, which may be search system 120 of FIG. 1, which may be used with the techniques described here. Computing device 400 is intended to represent various example forms of large-scale data processing devices, such as servers, blade servers, data centers, mainframes, and other large-scale computing devices. Computing device 400 may be a distributed system having multiple processors, possibly including network attached storage nodes, that are interconnected by one or more communication networks. The components shown here, their connections and relationships, and their functions, are meant to be examples only, and are not meant to limit implementations of the implementations described and/or claimed in this document.

Computing device 400 may be a distributed system that includes any number of computing devices 480 (e.g., 480a, 480b, . . . 480n). Computing devices 480 may include a server or rack servers, mainframes, etc. communicating over a local or wide-area network, dedicated optical links, modems, bridges, routers, switches, wired or wireless networks, etc.

In some implementations, each computing device may include multiple racks. For example, computing device 480a includes multiple racks (e.g., 458a, 458b, . . . , 458n). Each rack may include one or more processors, such as processors 452a, 452b, . . . , 452n and 462a, 462b, . . . , 462n. The processors may include data processors, network attached storage devices, and other computer-controlled devices. In some implementations, one processor may operate as a master processor and control the scheduling and data distribution tasks. Processors may be interconnected through one or more rack switches 462a-462n, and one or more racks may be connected through switch 478. Switch 478 may handle communications between multiple connected computing devices 400.

Each rack may include memory, such as memory 454 and memory 464, and storage, such as 456 and 466. Storage 456 and 466 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 456 or 466 may be shared between multiple processors, multiple racks, or multiple computing devices and may include a non-transitory computer-readable medium storing instructions executable by one or more of the processors. Memory 454 and 464 may include, e.g., volatile memory unit or units, a non-volatile memory unit or units, and/or other forms of non-transitory computer-readable media, such as a magnetic or optical disks, flash memory, cache, Random Access Memory (RAM), Read Only Memory (ROM), and combinations thereof. Memory, such as memory 454 may also be shared between processors 452a-452n. Data structures, such as an index, may be stored, for example, across storage 456 and memory 454. Computing device 400 may include other components not shown, such as controllers, buses, input/output devices, communications modules, etc.

An entire system may be made up of multiple computing devices 400 communicating with each other. For example, device 480a may communicate with devices 480b, 480c, and 480d, and these may collectively be known as outage detection system 126, search result generator 124, indexing system 128, query processor 122, and/or search system 120. Some of the computing devices may be located geographically close to each other, and others may be located geographically distant. The layout of computing device 400 is an example only and the system may take on other layouts or configurations.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor.

To provide for interaction with a user, the systems and techniques described here can be implemented on a computer having a display device (e.g., a CRT (cathode ray tube) LCD (liquid crystal display), or LED/OLED monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

A number of implementations have been described. Nevertheless, it will be understood that various modifications may be made without departing from the spirit and scope of the specification. While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims. Moreover, as used herein, ‘a’ or ‘an’ entity may refer to one or more of that entity.

Clause 1. A method comprising: for queries in a vertical, observing counts of user behaviors in response to the queries, the user behaviors having been identified as predictive of a feature outage in the vertical; calculating aggregated user behavior metrics for a most recent detection period; compare the aggregated user behavior metrics for the most recent detection period with aggregated user behavior metrics for a prior detection period to determine whether the aggregated user behavior metrics are within an expected range; and in response to the aggregated user behavior metrics for the most recent detection period being outside the expected range, initiating an action.

Clause 2. The method of clause 1, wherein comparing the aggregated user behavior metrics for the most recent detection period with the aggregated user behavior metrics for the prior detection period occurs using a feature outage detection model trained on time series data for queries in the vertical, the aggregated user behavior metrics observed over the most recent detection period being provided to the feature outage detection model as input.

Clause 3. The method of clause 2, wherein the aggregated user behavior metrics for the most recent detection period are calculated by source, device type, and vertical.

Clause 4. The method of clause 2, wherein the aggregated user behavior metrics for the most recent detection period are calculated by source, generalized location, and vertical.

Clause 5. The method of clause 2, wherein the aggregated user behavior metrics for the most recent detection period are calculated by source, generalized location, and user class, where the user class represents a frequency of the user behavior over an assignment period.

Clause 6. The method of clause 5, wherein users in class representing most frequent use of the user behavior are excluded from aggregating the user behavior during a detection period.

Clause 7. The method of clause 1, wherein the aggregated user behavior metrics for the most recent detection period are calculated by source and by vertical, the aggregated user behavior metrics that are outside the expected range are for a first source, and the action includes preventing the first source from responding to queries in the vertical.

Clause 8. The method of any of clauses 1 to clause 7, wherein the user behaviors include organic clicks.

Clause 9. The method of any of clauses 1 to clause 8, wherein the user behaviors include duplicate queries within a behavior window.

Clause 10. The method of any of clauses 1 to 9, wherein the user behaviors include manual query refinement within a behavior window.

Clause 11. The method of any of clauses 1 to 7, wherein the user behaviors include organic clicks, duplicate queries within a behavior window, and manual query refinement within the behavior window, and wherein the expected range represents at least two of the user behaviors increasing during the most recent detection period.

Clause 12. The method of any of clauses 1 to 11, wherein the detection period is based on an average time to receive a minimum number of queries.

Clause 13. The method of any of clauses 1 to 12, wherein calculating the aggregated user behavior metrics includes, for each user behavior of the user behaviors: assigning users to a class representing frequency of the user behavior over an assignment period, wherein users in class representing most frequent use of the user behavior are excluded from aggregating the user behavior during a detection period.

Clause 14. A method comprising: observing counts of user behaviors in a user interface, the user behaviors having been identified as predictive of a feature outage for the user interface; calculating aggregated user behavior metrics for a most recent detection period; compare the aggregated user behavior metrics for the most recent detection period with aggregated user behavior metrics for a prior detection period to determine whether the aggregated user behavior metrics are within an expected range; and in response to the aggregated user behavior metrics for the most recent detection period being outside the expected range, initiating an action.

Clause 15. The method of clause 14, wherein comparing the aggregated user behavior metrics for the most recent detection period with the aggregated user behavior metrics for the prior detection period occurs using a feature outage detection model trained on time series data for the user interface, the aggregated user behavior metrics observed over the most recent detection period being provided to the feature outage detection model as input.

Clause 16. The method of clause 15, wherein the aggregated user behavior metrics for the most recent detection period are calculated by source, device type, or generalized location.

Clause 17. The method of clause 15, wherein the aggregated user behavior metrics for the most recent detection period are calculated by source and user class, where the user class represents a frequency of the user behavior over an assignment period.

Clause 18. The method of clause 17, wherein users in class representing most frequent use of the user behavior are excluded from aggregating the user behavior during a detection period.

Clause 19. The method of any of clauses 14 to 18, wherein the aggregated user behavior metrics for the most recent detection period are calculated by source, the aggregated user behavior metrics that are outside the expected range are for a first source, and the action includes preventing the first source from responding to requests from the user interface.

Clause 20. The method of any of clauses 14 to clause 19, wherein the user behaviors include page refreshing within a behavior window.

Clause 21. A system comprising: at least one processor and memory storing instructions that, when executed by the at least one processor, causes the system to perform the operations of any of clauses 1 to 20.

Clause 22. A system comprising: at least one processor and memory storing instructions that, when executed by the at least one processor, causes the system to perform any of the operations or methods disclosed herein.

Clause 23. A computer-readable medium storing instructions that, when executed by at least one processor, causes a computing system to perform any of the operations or methods disclosed herein.

What is claimed is:

1. A method comprising:
for queries in a vertical, observing counts of user behaviors in response to the queries, the user behaviors having been identified as predictive of a feature outage in the vertical;
calculating aggregated user behavior metrics for a most recent detection period;
compare the aggregated user behavior metrics for the most recent detection period with aggregated user behavior metrics for a prior detection period to determine whether the aggregated user behavior metrics are within an expected range; and
in response to the aggregated user behavior metrics for the most recent detection period being outside the expected range, initiating an action.

2. The method of claim 1, wherein comparing the aggregated user behavior metrics for the most recent detection period with the aggregated user behavior metrics for the prior detection period occurs using a feature outage detection model trained on time series data for queries in the vertical, the aggregated user behavior metrics observed over the most recent detection period being provided to the feature outage detection model as input.

3. The method of claim 2, wherein the aggregated user behavior metrics for the most recent detection period are calculated by source, device type, and vertical.

4. The method of claim 2, wherein the aggregated user behavior metrics for the most recent detection period are calculated by source, generalized location, and vertical.

5. The method of claim 2, wherein the aggregated user behavior metrics for the most recent detection period are calculated by source, generalized location, and user class, where the user class represents a frequency of the user behavior over an assignment period.

6. The method of claim 5, wherein users in class representing most frequent use of the user behavior are excluded from aggregating the user behavior during a detection period.

7. The method of claim 1, wherein the aggregated user behavior metrics for the most recent detection period are calculated by source and by vertical, the aggregated user behavior metrics that are outside the expected range are for a first source, and the action includes preventing the first source from responding to queries in the vertical.

8. The method of claim 1, wherein the user behaviors include organic clicks.

9. The method of claim 1, wherein the user behaviors include duplicate queries within a behavior window.

10. The method of claim 1, wherein the user behaviors include manual query refinement within a behavior window.

11. The method of claim 1, wherein the user behaviors include organic clicks, duplicate queries within a behavior window, and manual query refinement within the behavior window, and wherein the expected range represents at least two of the user behaviors increasing during the most recent detection period.

12. The method of claim 1, wherein the detection period is based on an average time to receive a minimum number of queries.

13. The method of claim 1, wherein calculating the aggregated user behavior metrics includes, for each user behavior of the user behaviors:
assigning users to a class representing frequency of the user behavior over an assignment period,
wherein users in class representing most frequent use of the user behavior are excluded from aggregating the user behavior during a detection period.

14. A system comprising:
observing counts of user behaviors in a user interface, the user behaviors having been identified as predictive of a feature outage for the user interface;
calculating aggregated user behavior metrics for a most recent detection period;
compare the aggregated user behavior metrics for the most recent detection period with aggregated user behavior metrics for a prior detection period to determine whether the aggregated user behavior metrics are within an expected range; and
in response to the aggregated user behavior metrics for the most recent detection period being outside the expected range, initiating an action.

15. The system of claim 14, wherein comparing the aggregated user behavior metrics for the most recent detection period with the aggregated user behavior metrics for the prior detection period occurs using a feature outage detection model trained on time series data for the user interface, the aggregated user behavior metrics observed over the most recent detection period being provided to the feature outage detection model as input.

16. The system of claim 15, wherein the aggregated user behavior metrics for the most recent detection period are calculated by source, device type, or generalized location.

17. The system of claim 15, wherein the aggregated user behavior metrics for the most recent detection period are calculated by source and user class, where the user class represents a frequency of the user behavior over an assignment period.

18. The system of claim 17, wherein users in class representing most frequent use of the user behavior are excluded from aggregating the user behavior during a detection period.

19. The system of claim 14, wherein the aggregated user behavior metrics for the most recent detection period are calculated by source, the aggregated user behavior metrics that are outside the expected range are for a first source, and the action includes preventing the first source from responding to requests from the user interface.

20. The system of claim 14, wherein the user behaviors include page refreshing within a behavior window.

21. A computer-readable medium storing instructions that, when executed by at least one processor, causes a computing system to perform operations comprising:
observing counts of user behaviors in a user interface, the user behaviors having been identified as predictive of a feature outage for the user interface;
calculating aggregated user behavior metrics for a most recent detection period;
compare the aggregated user behavior metrics for the most recent detection period with aggregated user behavior metrics for a prior detection period to determine whether the aggregated user behavior metrics are within an expected range; and
in response to the aggregated user behavior metrics for the most recent detection period being outside the expected range, initiating an action.
